(19) United States
(12) Patent Application Publication
(10) Pub. No.: US 2026/0004194 A1
(43) Pub. Date: Jan. 1, 2026

(54) SAFE LEARNING WITH ALERT AND REVIVE MODEL

(71) Applicant: YONUX LLC, Baltimore, MD (US)

(72) Inventor: Jia XU, Hoboken, NJ (US)

(73) Assignee: YONUX LLC, Baltimore, MD (US)

(21) Appl. No.: 19/254,964

(22) Filed: Jun. 30, 2025

Related U.S. Application Data
(60) Provisional application No. 63/665,326, filed on Jun. 28, 2024.

(51) Int. Cl. G06N 20/00

(52) U.S. Cl. CPC G06N 20/00

(57) ABSTRACT

Example embodiments of the present disclosure relate to safety of machine learning models. According to example embodiments, a method for improving the safety of a machine learning model may be provided, the method including determining, based on confidence matching, whether the machine learning model is below a predefined confidence standard, generating an alert that if the estimated output quality is below the predefined confidence standard, retraining the machine learning model based on the alert, and regenerating results and retraining the system, and validating the retrained machine learning model to determine whether the retrained machine learning model is equal to or above the predefined confidence standard iteratively until an estimated safety is ensured.

### CROSS REFERENCE TO RELATED APPLICATIONS

This application claims priority to U.S. provisional application No. 63/665,326 filed with the U.S. Patent and Trademark Office on Jun. 28, 2024 and entitled “INVINCIBLE MACHINE LEARNING AND SAFE SELF LEARNING”, the disclosure of which is incorporated herein by reference in its entirety.

### TECHNICAL FIELD

Example embodiments of the present disclosure relate to deep learning and machine learning models, and more particularly, safety validation for machine learning models.

### BACKGROUND

The information disclosed in this background section is only for the enhancement of understanding of the general background of the disclosure and should not be taken as an acknowledgment or any form of suggestion that this information forms the prior art already known to a person skilled in the art.

In the related art, machine learning (ML) models may be used to automate a variety of tasks (e.g., image classification, language processing, and games). However, the safety of models used in deep learning (DL) has been a subject of investigation, and inadequate predictions can have serious consequences for real applications and may cause significant consequences for medical diagnosis, autonomous driving, and financial services. In this regard, safety in the context of ML models may be used to determine the confidence of a model and its corresponding system to operate-accurately (e.g., with reliable decisions) and without outputting content that has ethical issues (e.g., without content violations) across diverse environments, particular within unknown or “high-stakes environments” where failure of the ML applications have significant or critical outcomes.

### SUMMARY

Example embodiments of the present disclosure provide devices, systems, devices, methods, and the like, that implement safety validation for machine learning models.

According to example embodiments, a method for validating the safety of a machine learning model may be provided, the method including: determining, based on confidence matching, whether the machine learning model is below a predefined confidence standard; based on determining that the machine learning model is below the predefined confidence standard, generating an alert that the confidence standard is below the predefined confidence standard; retraining the machine learning model based if alerted; regenerating an output if alerted, and validating the retrained machine learning model to determine whether the retrained machine learning model is equal to or above the predefined confidence standard.

Determining whether the machine learning model is below the confidence measure may be based on a contrastive safety confidence measure. Determining whether the machine learning model is below the confidence measure may be based on an anti-hack safety definition for the machine learning model. Truth measures such as credit sources and multi-agent consistency may also be considered. Determining whether the machine learning model is below the confidence measure may be based on multimodal consensus.

Retraining the machine learning model may be performed iteratively based on prompts in weak prediction areas of the machine learning model. Validating the retrained machine learning model may be based on a leave-one-out test in a plurality of domains from a given domain.

According to example embodiments, a computing device may be provided, including a memory device configured to store computer-readable instructions; and a processing device communicatively coupled to the memory device and configured to execute the instructions to validate the safety of a machine learning model by: determining, based on confidence matching, whether the machine learning model is below a predefined confidence standard; based on determining that the machine learning model is below the predefined confidence standard, generating an alert that the confidence standard is below the predefined confidence standard retraining the machine learning model based if alerted; regenerating an output if alerted, and validating the retrained machine learning model to determine whether the retrained machine learning model is equal to or above the predefined confidence standard.

According to example embodiments, a non-transitory computer-readable recording medium having recorded thereon instructions executable by a computing device to cause the computing device to validate the safety of a machine learning model by performing a method may be provided, the method including: determining, based on confidence matching-confidence matching and related content seem to be redundant in many places—, whether the machine learning model is below a predefined confidence standard; based on determining that the machine learning model is below the predefined confidence standard, generating an alert that the confidence standard is below the predefined confidence standard; retraining the machine learning model based if alerted; regenerating an output if alerted; and validating the retrained machine learning model to determine whether the retrained machine learning model is equal to or above the predefined confidence standard.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates an example system configuration for implementing safety validation including an iteration loop, according to one or more example embodiments;

FIG. 2 illustrates an example high-level system configuration for implementing safety validation with collective intelligence, according to one or more example embodiments;

FIG. 3 illustrates a mapping of a semantic space for high-stake, unknown, and safe zones, according to one or more example embodiments;

FIG. 4 illustrates contrastive distribution distance, according to one or more example embodiments;

FIG. 5 illustrates anti-hack resilience for unknown and high-stakes zones, according to one or more example embodiments;

FIG. 6 illustrates a block diagram for training a reward model for fact ecology, according to one or more example embodiments;

FIG. 7 illustrates a block diagram for performing reinforcement learning on a reward model for fact ecology, according to one or more example embodiments;

FIG. 8 illustrates a block diagram of an example method for performing a consistency check, according to one or more example embodiments;

FIG. 9 illustrates an example block diagram of a leave-one-out test for validating safety metrics, according to one or more example embodiments;

FIG. 10 illustrates an example block diagram of evaluating and retraining a model using a safety framework, according to one or more example embodiments;

FIG. 11 illustrates an example epsilon-alpha safety curve for defining safety probability, according to one or more example embodiments;

FIG. 12 illustrates an example block diagram for iteratively retraining a model, according to one or more example embodiments;

FIG. 13 illustrates an example block diagram of a method for validating model safety, according to one or more example embodiments; and

FIG. 14 illustrates a diagram of example components of a system, according to one or more example embodiments.

### DETAILED DESCRIPTION

The following detailed description of example embodiments refers to the accompanying drawings. The foregoing disclosure provides illustration and description, but is not intended to be exhaustive or to limit the implementations to the precise forms disclosed. Modifications and variations are possible in light of the above disclosure or may be acquired from practice of the implementations. Further, one or more features or components of one embodiment may be incorporated into or combined with another embodiment (or one or more features of another embodiment). Additionally, the flowchart and description of operations provided below relate to one of the various embodiments. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, firmware, or a combination of hardware and software. The actual specialized control hardware or software code used to implement these systems and/or methods is not limited to the described implementations. Thus, the operation and behavior of the systems and/or methods are described herein without reference to specific software code. It is understood that software and hardware may be designed to implement the systems and/or methods based on the description herein.

Even though particular combinations of features are disclosed in the claims and/or in the specification, these combinations are not intended to limit the disclosure of implementations. In fact, many of these features may be combined in ways not specifically recited in the claims and/or disclosed in the specification. Although each dependent claim listed below may directly depend on only one claim, the disclosure of implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]”, are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “embodiment,” “non-limiting exemplary embodiment,” “example embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

The term “out-of-domain” as used herein may refer to test data which falls outside of a model's scope on which it was trained. A model may exhibit poor performance or unexpected behavior from lack of exposure to these inputs.

The term “unknown domain” or “unknown zones” as used herein may refer to a test domain or test zone which has its information remain entirely unknown or unseen during the model's training phase, but may be approximately simulated using leave-one-out strategies with known test distributions. Unknown domains may provide significant challenges as the model needs prior information about where it will be launched, and may otherwise pose erroneous decisions when a system launches if not dealt with.

The term “high-stakes environment” or “high-stake zones” as used herein may refer to situations where consequences of errors or failures in the system may have a significant, critical, severe outcome. Reliability of the ML model in this system may be crucial for making important decisions or ensuring safety. This may include conversations that may trigger unethical behaviors or risky consequences, such as hate and violent speech.

The term “safety” or “safe zones” as used herein may refer to the assurance and confidence of a system operating stably and reliably across a diverse environment, even in unknown or high-stakes environments, without harming outcomes. In particular, it may refer to providing ethical and accurate responses, ensuring that systems operate stably and reliably without causing harm or mistakes. In contrast, an “unsafe zone” refers to a complement set which is either a high-stake zone or unknown zone.

The term “collective intelligence” (CI) as used herein may refer to a shared or group intelligence which may emerge from collaboration, collective efforts, and/or competition among individuals, which may be used in consensus-based decision making, focusing on the general ability of a group to perform a wide variety of tasks.

The term “confidence matching” as used herein may refer to any measurement which may be used to quantify and assess the likelihood of the safety of a ML model at each stage (e.g., algorithm) as well as its system. This may be in an environment where an alert is set if the confidence value falls below a predefined standard.

The term “model architecture independence” as used herein may refer to a system which works independently of neural network architecture, losses in pre-training or fine-tuning, and data domains for supervised tasks and reinforcement learning. The term “safety framework” may also be used to refer to the same entity interchangeably.

Safe learning in the related art does not implement explicit Alert-Revive mechanisms, particularly for unknown domains and high-stake environments. For alert safety, conventional domain adaptation approaches require target domain knowledge, which means that test scenarios may be out-of-domain or unknown prior to system launch. The domain shift cannot be generalized either. Accordingly, a system tuned for a specific test domain may lose performance on its original training or other domains. Reasoning and confirming truth may also be difficult for related art systems due to missing standards. While a human validate may use multimodal perceptions to cross-check an input (e.g., vision, speech, reading text), existing literature for ML systems may only use a single modality. Data may also experience changes, making it impractical to acquire ground truth for the ML model. There is a lack of monitoring tools which can handle complex structures in this regard—not only robust learning related literature, check the “related work” sections in both pdf file shared and add these discussions.

For revive safety, related art systems may have difficulty in decoding input data which is uncommon, for example including noise, interference, ambiguity, corruption, or changing conditions. The system output may end up being incorrect or nonsensical because of such uncertainty and unpredictability, making it difficult to define and learn special rules individually, thereby posing instability challenges during model development. There may also be discrepancies between training errors and test errors, which result in generalization errors (generalization in this context referring to the measure of accuracy of an algorithm in predicting unseen data).

Content violation issues may be prevalent in related art systems. In particular, a content violation may include a sensitive utterance or topics (e.g., hate speech) which may not be present in labeled data, which may make it difficult for a ML model such as a Large Language Model (LLM) to capture and prohibit. It is imperative that the LLM can automatically detect such content, and divert discussions away to ensure safe responses. Content violations may be part of a high-stake zone in the semantic space, which is an area where failures can have significant or severe/critical outcomes.

Related art systems may also have substantial issues identifying the trustworthiness of an information source. In particular, LLM generated misinformation may arise from various sources, whereas there is no standard labelling for trustworthiness in the related art. LLM outputs may also be inconsistent with themselves or outputs from other models. Lack of factuality supervision makes it difficult to obtain reliable factuality labels for training detection models, especially for scenarios and expressions involving inconsistent utterances.

Related art systems may also struggle with biased sampling. For example, a common problem in data augmentation may be that the added samples are too tuned towards a specific test domain and dataset, such that when the system is rebuilt, it is unstable or perform sub optimally. The system may also be static and unable to identify problems itself and seek solutions thereof (e.g., it cannot be updated without instructions since it does not know its own issues/weaknesses in its own semantic space). Such LLM's may also suffer from infrequent updates, resulting in responses which are outdated.

Related art systems may also struggle with safety validation. In particular, current evaluation criteria on system performance may primarily rely on accuracy to measure similarity between prediction output and a human label of given sets. However, these pre-determined datasets need to be more accurate because of discrepancies between them and real tests in open world. Moreover, there needs to be more quality guarantees bounding the system performance on unknown data, and adversarial cases are atypical and not practical.

In view of the above, there is a need for improved safety definitions and evaluation framework to measure the safety of learning systems, and to improve the safety of models.

Example embodiments of the present disclosure, as described in the following, provide devices, systems, methods, and the like, that implement safety validation, and ultimately address the shortcomings of the related art as described above.

Example embodiments may augment training data to maximize system performance and detect and alert system risks in real-time. This may be associated with each decision before or during system deployment. Safety metrics may be defined for unknown domains or high-stakes environments, and utilized to measure confidence for alerts, thereby estimating the confidence measure through multimodal consensus and can be used for filtering training data issuing alerts during system testing. The system may also be monitored with model explanation during deployment.

Example embodiments may implement safety in terms of the entire end-to-end system of an ML model and its interaction with the environment. Safety may be used to measure a system's safety, meaning that a robust system will behave stably and robustly for individuals and environments, when domains change and not outputting harmful results.

Based on the above embodiments, it can be understood that an example effect which may be achieved includes improving detection of ML models which are below a safety threshold, and improving safety of ML models by retraining. Accordingly, robust ML models may mitigate algorithmic failure (which could otherwise lease to physical harm), improve data privacy, avoid algorithmic bias, and improve ethical decision-making.

It is contemplated that features, advantages, and significance of example embodiments described hereinabove are merely a portion of the present disclosure, and are not intended to be exhaustive or to limit the scope of the present disclosure. Further descriptions of the features, components, configuration, operations, implementations, and example use cases of the example embodiments of the present disclosure are provided in the following.

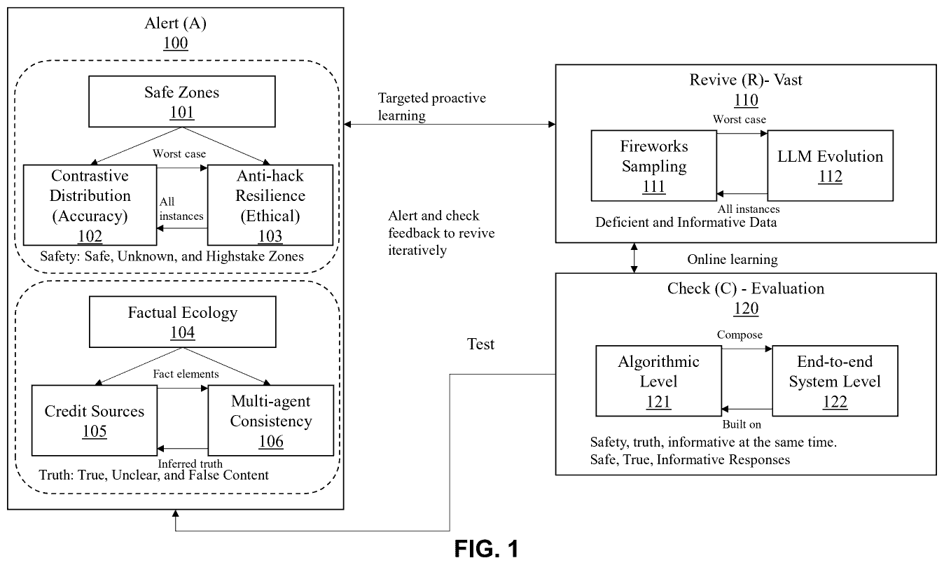

FIG. 1 illustrates an example system configuration for implementing safety validation including an iteration loop, according to one or more example embodiments.

Alert (A) 100, Revive (R)—Vast 110, and Check (C)—Evaluation 120 in combination may comprise an Alert-Revive-Check (ARC) model.

Alert 100 may include safe zones 101, contrastive distribution (for checking accuracy) 102, and anti-hack resilience (for checking ethics) 103 as elements for generating safety alerts. In particular, contrastive distribution 102 and anti-hack resilience in combination may contribute to identifying safe, unknown, and highstake zones, in order to generate a safety alert to alert of risky behaviors of the system and prevent system failures in unknown and high-stake zones. It should be appreciated that safety alerts may be generated based on a confidence score for two aspects: (A) accuracy may determine whether responses meet accuracy substandards, and alert to as “unknown” if it fails, and (B) ethics may detect unreliable responses, including those related to illegal activities, violence, self-harm, dangerous practices, privacy concerns, etc., and alert to as “high-stake” if it fails (e.g., falls below ethical standards). If either accuracy of ethical standards in (A) or (B) are not met, an “unsafe” decision will be alerted by Alert 100, otherwise it may be marked as “safe”.

Contrastive distribution 102 may measure the distribution distance, in order to alert of high-stake zone queries. A safe query and response should be far from sensitive topics within the semantic space. In the worst case, the contrastive distribution will also rely on anti-hack distribution 103.

Anti-hack resilience 103 may break down adversarial attacks from unknown zones, and trigger an alert when system confidence mismatches expectations. In all cases, anti-hack resilience may also utilize contrastive distribution 102 to ensure the response is far from a sensitive topic.

Alert 100 also includes factual ecology 104, credit sources 105, and multi-agent consistency 106 as elements for generating truth alerts. In particular, credit sources 105 and multi-agent consistency in combination may contribute to identifying true, unclear, and false content, in order to generate a truth alert to alert of the truthfulness of the model output. Results may be categorized into three classifications, (A) true, in which responses meet factual standards, (B) false, in which responses contradict established facts, and (c) unclear, in which responses are neither supported by facts nor directly contradict.

Credit sources 104 may be used to obtain fact elements, and the credibility of the source agency may be learned online while producing verification results.

Multi-agent consistency 106 may deploy neural concept methods which measure confidence based on the distance of training and development data to provide explanatory insights for alerts. Accordingly, it may be understood that it infers the truth based on the fact elements obtained from credit sources 104.

Generated alerts from alert 100 may be used either for LLM deployment (e.g., to capture risky cases), or for reviving the LLM by retraining (using revive 110 and proactive learning for example).

Revive 110 may include fireworks sampling 111 and LLM evolution 112. Revive 110 aims to augment training data sampled from the semantic space in which there is system weakness, then retrain the system to improve its safety (with respect to accuracy, ethics) and truthfulness with proactive learning and/or online learning. Firstly, the system weakness may be learned for sampling, then proactive learning may be performed in combination with proactive learning methods with respect to alert 100. Afterwards, online learning may be performed using feedback from check 120 (Described below). This may be performed iteratively to achieve lifelong learning for the system.

Fireworks sampling 111 specifically is a method which takes a seed as an input and generates a set of sample points in the geometric space (e.g., embedding a realized semantic space). To reduce the bias for the data generation process, randomness is introduced into the sampling of the seed set. A set of high-dimensional spheres may be created around the origin of a seed point. While the spheres' radius grows from zero to theoretical infinity, it may be limited in practice to a fixed size as a tunable hyperparameter. The smaller the radius, the higher the probability a sample may be selected on the sphere of this radius. This approach allows for a generation of a set of points around the seeds, with the number of points anti-proportional to their distance from the seed points (like real-life fireworks). Accordingly, randomness may be incorporated into the seeds, thereby producing a more reliable sample set.

Fireworks sampling 111 is used to add randomness into data augmentation in order to reduce bias and noise affected from data generation using only erroneous samples. A random walk may be performed in order to sample areas which follow a non-uniformly random sampling with the distribution as a normalized confidence measure scores from both the safety and truth alert process. The non-uniform sampling allows the generation of more data from areas of lower confidence and vice-versa, such that the generation captures a wider spectrum and well-distributed data points, maximizing the overall entropy. A gradient descent of anti-hack proactive learning and multi-agent proactive learning may also be used.

While performing a random walk and/or a search process, firework sampling 111 may be used to augment new data points. This may include collecting seeds by considering the area of alerts (A) 100 in the semantic space (e.g., word/sentence embedding) due to low confidence in measures of safety or truth by finding alerted samples, distributions, and the LLM as agents. In these areas, the average confidence scores of ethics and truth-fullness may be low (e.g., fall under unknown zones, unclear, or false content areas). Seeds may also be considered with reference to the area of erroneous query outputs in Check 120 from temporal past data points (for example, errors in classifying a previous data of an incorrect query output of a first type (rain) may be used to retrain the model to predict the correct query output of a second type (sun)). Once these areas are located, revive 110 may be performed.

The seed set may include the trajectories from the system weakness as a labeled sample set. They may be system-specific, task-specific, and domain tested. This may be labeled with prompt results approximately, or with human experts in the loop. When retraining the system in the next generation, these trajectories will be utilized as instructional samples for lower regrets for the future.

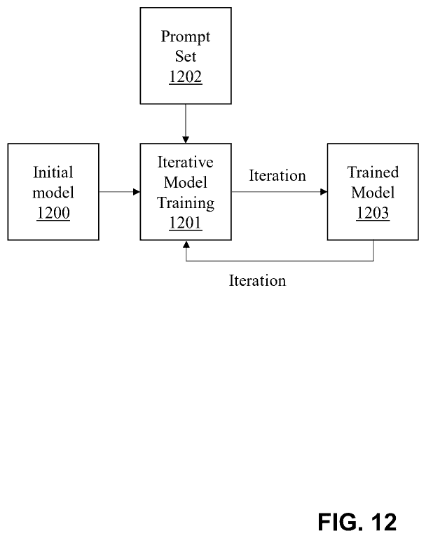

LLM evolution 112 may include proactive learning and online learning. In order to learn from failures and incorporate knowledge into retraining, LLM evolution 112 may include methods for memorizing past error patterns based on LLM evolution. These results may be used in combination with Alert 100 and Check 120. LLM evolution 112 may include finding new system weakness for another round of firework sampling 111. This process is performed iteratively to produce LLM by generation until the system converges. Accordingly, static and fragile models may grow into dynamic and stable ones which are invulnerable to attacks and noisy environments. This may firstly include reinforcement learning. Details regarding reinforcement learning are described with reference to FIG. 12 below.

Proactive learning may include steps of:
(1) Computing confidence measures using contrastive safety confidence measure and source credits-based truth confidence measurements;
(2) Algorithms of random walk or search based on results from (1);
(3) fireworks sampling and new data generation based on lesson set seeds;
(4) retraining target LLM using newly sampled data;
(5) evolution of target LLM using reinforcement learning/reinforcement learning from human feedback.

In addition to proactive learning, online learning may used to further improve the model given that past user queries and feedback are available. This may include:
(6) computing errors of past queries in history as in check 120;
(7) fireworks sampling and generating new data based on lesson set seeds made only of erroneous past queries;
(8) retraining target LLM using newly sampled data;
(9) evolving the target LLM using reinforcement learning/reinforcement learning from human feedback.

Check 120 may include checking on algorithmic level 121 and end-to-end system level 122. Specifically, each component in the system may be evaluated on algorithm level 121 and end-to-end system level 122. These evaluation results may be used by revive 110 to improve model performance with respect to safety, truthfulness, and information content. In particular, the safety and truthfulness aspect achieved (based on detection in alert 100), and the informative data (based on revive 110) be used in combination to improve the overall model performance.

Check 120 may serve for standard evaluation to testify experimental results, and indicate system weakness which is applied in revive 110.

At algorithm level 121, the key algorithm's effectiveness including robustness and system upgrades may be evaluated. Systems are halted, given an alert, and evaluated accordingly. Contrastive distribution may be evaluated for accuracy, ethics, and efficiency 102. Anti-hack resilience 103 may be evaluated for accuracy, ethics, and efficiency. Credit sources 105 maybe evaluated for accuracy, truth, and efficiency. Multi-agent consistency 106 may be evaluated for accuracy, truth, explainability, and efficiency. Fireworks sampling 111 may be evaluated for accuracy, ethics, truth, efficiency, and multimodality. LLM evolution 112 may be evaluated in terms of accuracy, ethics, truth, and efficiency.

At system level 122, the effective of ARC may be evaluated with reference to enhancing safe and truth learning. This may be compared to system performance without using ARC of text-only and multimodality models, using chatbot dialogue of an LLM application.

Accuracy of unknown zones may be considered by implementing an alert mechanism to enhance accuracy compared against baselines. A leave-one-out approach may be used to simulate unknown domains and conduct real scenario tests to compute accuracy across domains to compare against baseline systems.

Ethics for high-stakes zones may be tested on designed adversarial attacks, although in real-world applications these may not necessarily happen, such that human evaluations may also be used for a fair evaluation.

Truth (true, false, unclear) may be considered by evaluation misinformation against prior work, by collecting expert ratings on information coverage and correctness, and measuring verifiable truth ratios through search and inference. Existing datasets may be used for automatic evaluation and conducting manual assessments with random and counter samples. Human evaluations may be involved when reviewing user feedback.

Information coverage (deficient, informative) may be used to assess language model performance while evaluating misinformation based on comparisons. Expert ratings may also be used for measuring information content coverage and correctness to verify improvements in truthful outputs of proposed systems versus baselines.

Multimodality may be considered using frameworks such as fake news detection. Success rates may be compared against baseline systems based on metrics such as precision and recall.

Explainability may be considered by human experts based on a score to verify the usefulness of explained reasons for modelling alerts.

Efficiency may be considered with respect to training time, decoding time, memory requirements for efficiency comparison of proposed methods and baseline methods.

In view of the above, alert 100, revive 110, and check 120 in combination may formulate an iterative loop. Specifically, alert 100 and check 120 may be used to determine whether there is an issue for feedback, and then revive 110 may iteratively be performed in order to improve the system.

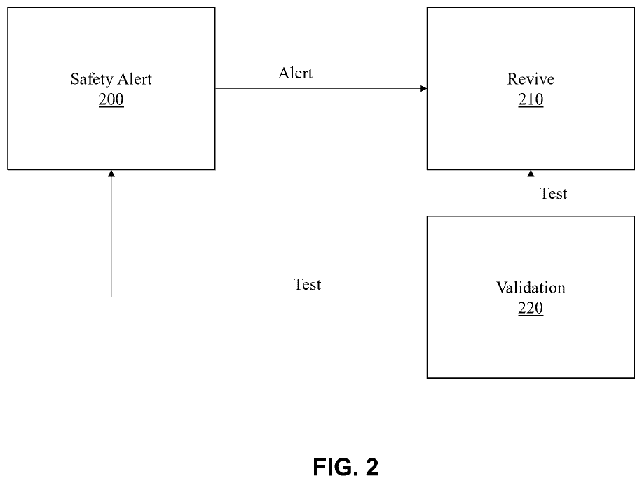

FIG. 2 illustrates an example high-level system configuration for implementing safety validation with collective intelligence, according to one or more example embodiments

Safety alert 200, revive 210, and validation 220 may be provided as part of a safety framework for evaluating and retraining a machine learning model with respect to one or more safety metrics.

Safety alert 200 may be used to implement confidence matching. It may include collective definitions on unknown domains and high-stakes environment which may include leave-one-out sampling, probabilistic safety, and anti-hack safety. Collective multimodal perception may also be implemented to apply multiple modalities, (e.g., images, and text) to check consistency of different perceptions and alert if the consistency is below expected. Collective explainable modeling may also be implemented based on and neural concept reasoning to measure confidence based on the distance of training and deployment data, thereby providing explanatory insights for alerts.

Multimodal consensus may aim to detect untruthful data, devise labels and synthetic data to train truthful models including multimodality information, and make models more truthful before, during, or after training along with evaluation thereof. Example embodiments may implement self/unsupervised learning methods to discover truthfulness definitions based on context, and data may also be augmented based on real-world scenarios. A combination of visual and language modalities may be used, but it should be appreciated that further combinations (e.g., speech, mesh, point cloud, video) may be used.

Truth metrics using multimodal consensus may consider each modality, such as vision and language, as a distinct channel. For example, if an image shows that a river is located east of a building, the textual information should agree with this. If it does not, voting may be performed based on majority descriptions across different channels in order to correct untruthful content based on consensus.

Truthful data alignment may be done by curating training data to have consensus criterion and mapping pair of modalities using existing datasets and learning conversion embedding. Few-shot or zero-shot learning may be performed to train a model across all modalities.

Once synthetic data is generated and a dynamic consensus definition is established within the dataset, results may be applied to ensure the truthfulness of the model output such as within the chatbot. This may include prior training examination to exclude conflicting data across multiple modalities prior to training, within training to fine-tune the pre-trained model which exhibits distrustfulness to improve its truthfulness using correction data, and after training to correct the distrustful model by rectifying the potentially incorrect output to combine the posterior distribution with an amended model. These steps may be performed individually or in combination sequentially.Data point sampling using property testing and human-based verification may be used to verify the truthfulness.

If safety alert 200 considers that the confidence value (e.g., the safety score) of the ML model is below a predetermined confidence/safety standard/value, then safety alert 200 may trigger an alert and send it to revive 210. For example, multimodality alert may be done by setting a threshold of matching similarity and trigger alerts when the similarity is below a threshold. The threshold may be sent by optimizing the held-out dataset. The matching similarity can be computed based on a cosine similarity of embedded instances such as image and text embedding trained in the same space. For example, using pre-trained text-image models. The algorithm can be further improved by linearly combining weighted modalities (e.g., assigning a higher weight to text and lower weight to images for a chatbot applications and the reverse for CV tasks). These weights may be optimized.

Revive 210 may be triggered when safety issues are detected. Actions may be performed to enhance safety of the ML deployment and may be utilized for life-long learning of the system. Collective decisions for deficiency handling may be implemented. This may include a “slow-thinking” strategy in which there is a trade-off between decoding time and memory in order to achieve a more reliable decisions. In some implementations where tasks are overly complex, a human-in-the-loop may also be included. Collective data by prompting with lessons may also be implemented. Methods which build systems for improved generalization and safety properties may be included. For example, if the system fails despite risk case handling, it may be able to learn from the failure and incorporate the knowledge into re-training in order to avoid similar mistakes in future deployments. Methods may memorize past error patterns and penalize them in future predictions based on prompt design, growth, and evolution.

Once revive 210 has retrained or fine-tuned the ML model, it may be sent to validation 220 for testing.

Validation 220 may achieve a safety alert during model deployment by simulating the unknown domains and high-stake environments according to safety definitions using, for example, a leave-one-out test, which can gauge the likelihood of a system's performance remaining within a specific safety threshold for any input. The validation may consider each algorithm and the entire end-to-end system to maintain acceptable levels of risk.

Algorithm level validation may evaluate each key algorithms effectiveness, including safety checks and system updates. For each algorithm, the system may be halted, given an alert, and evaluated. For example, collective definitions may be validated based on accuracy, and evaluation on evaluation. Collective perception may be validated based on accuracy and analysis ability. Collective explainable modeling may be evaluated based on accuracy and explainability. Collective decisions may be evaluated based on accuracy and efficiency. Collective data may be evaluated based on accuracy and efficiency.

System level validations may be evaluated based on the effectiveness of the safety framework for enhancing robust learning to analyze unknown domains (which may be evaluated using the leave-one-out and real scenario approach) and high-stakes environments (which may be evaluated by selecting high risk samples).

A first example may be a natural language processing (chatbot) application. GPT-based data may be collected with a plurality of domains to simulate unknown domains using leave-one-out. In this test, human evaluators may randomly query the chatbot and query any domain when the system launches. The accuracy of each domain may be computed. The safety definitions are described herein may be used as evaluation criteria of the system stability test results. The success rates of the methods and the baselines systems may be considered. From all the test domains, test sentences which fall of the tail end of the probabilistic safety measures may be on the border of the anti-hack safety measure by tuning hyperparameters on the validation set. These are sentence queries which may have more risk (lower probability of being answered correctly). For collective definitions, perception and explainable modeling, an alert mechanism may be applied to measure how much the accuracy improved by filtering out the alerted instances over the baselines. For the collective decisions and data augmentation, the system may be compared with the new decisions and fine-tune the collected data with the baselines on performance and efficiency of computation time and memory requirement. Explainability may be verified based on, for example, a human reading through explainable text through samples and rating it based on the usefulness of data. Evaluation on evaluation may be performed based on leave-one-out to evaluate the simulated unknown domain and correlation with manual evaluation on a pair-wise system comparison to evaluate probabilistic safety and anti-hack safety evaluation strategy. In the collective decision, consistency of the multimodality of text and image may be measured, and a human may label the data. A classifier may be implemented based on labeled data to determine consistency incorrectness in the error rate. Efficiency may be measured based on training time (pre-training and fine-tuning), decoding time, and memory requirement for the efficiency comparison.

A second example may include a lung cancer detection mechanisms as a primary domain, and a kidney cancer detection mechanism as an unknown domain. Based on applying models trained on lung cancer data, the same model may be applied on the system for kidney cancer without providing domain-specific knowledge. Leave-one-out may be used to simulate the unknown domain. Accuracy of the kidney cancer domain may be computed based on the safety definitions described herein, and used as evaluation criteria. In this context, false positives and false negatives may be considered as misdiagnosis and treated as high-stakes environments. The alert mechanism may be applied to measure the accuracy by filtering out alerted instances over the baselines in order to evaluate the collective definitions and perception. For collective decisions and data augmentations, the system may be compared with new decisions and fine-tune the collected data with baselines on performance and efficiency. Evaluation on evaluation, analysis, and efficiency may be similar to the NLP example above.

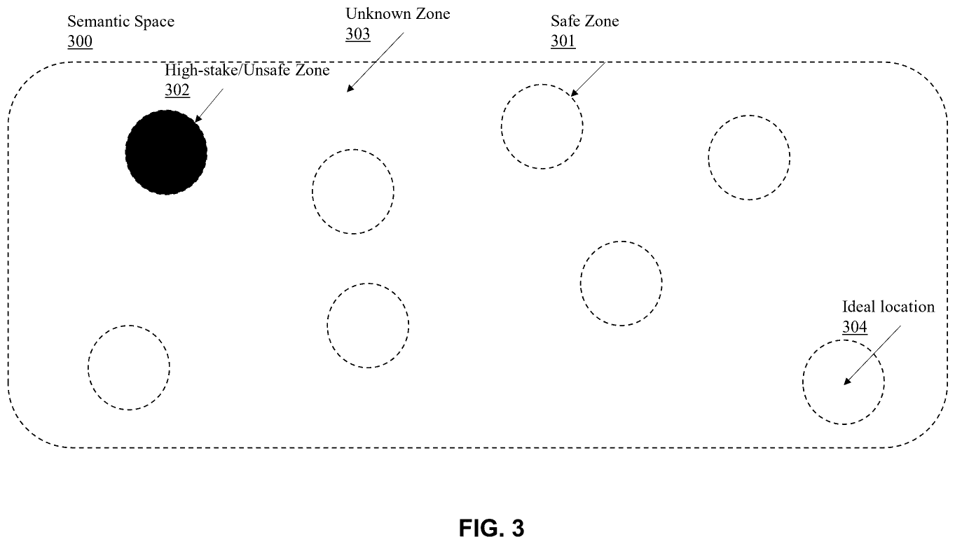

FIG. 3 illustrates a mapping of a semantic space 300 for high-stake, unknown, and safe zones, according to one or more example embodiments. Semantic space 300 may be used to measure the zone of where a query or a response resides.

Safe-zone 301, high-stake/unsafe zone 302, unknown zone 303, and ideal location 304 are illustrated. As previously mentioned, a high-stake/unsafe zone 302 (denoted by a dark spot) may be one which includes unethical utterances, whereas unknown zone 303 (the blank areas of semantic space 300) are unreliable responses in which there was lack of data samples during LLM training, and safe-zone 301 (denoted by a light spot) is an ethical and known area.

Ideal location 304 is considered as “ideal” since it is close to a distribution of a safe zone, and far from a distribution of an unknown zone and avoids high-stake zones. The closer a response is to a safe zone, the safer the associated topic. On the contrary, the high-stake/unsafe zones are areas which safety is unwarranted and should be avoided.

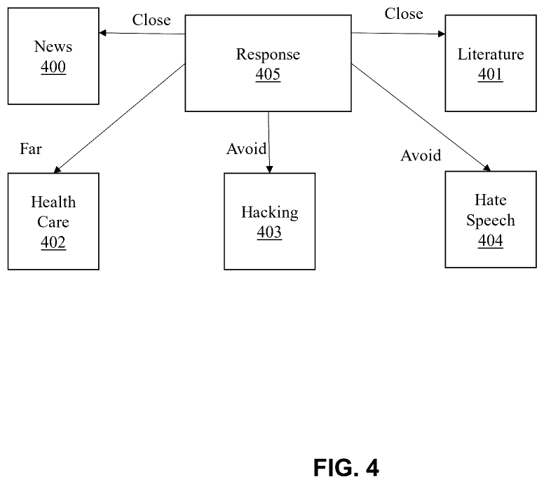

FIG. 4 illustrates contrastive distribution distance, according to one or more example embodiments.

Measuring confidence in accuracy to alert on unknown instances in decision making may be performed by monitoring the distance between data distributions of training and deployment data. A method such as applying Kullback-Leibler divergence, relative entropy, and a robustness measure may be performed to consider how a neural network changes dynamically, thereby explaining mismatches to enhance control and response accuracy. This may be used to compute distances within the distribution, and establish the thresholds which define the safe, unsafe, and unknown zones as tunable parameters.

Response 405 may be identified in terms of its relative distance from a distribution of a safe zone (e.g., including news 400 and literature 401), an unknown zone (e.g., health care 402), and a high-stake zone (hacking 403 and hate speech 404). Response 405 should be close to the safe zones, far away from the unknown zones, and avoid the high-stake zone.

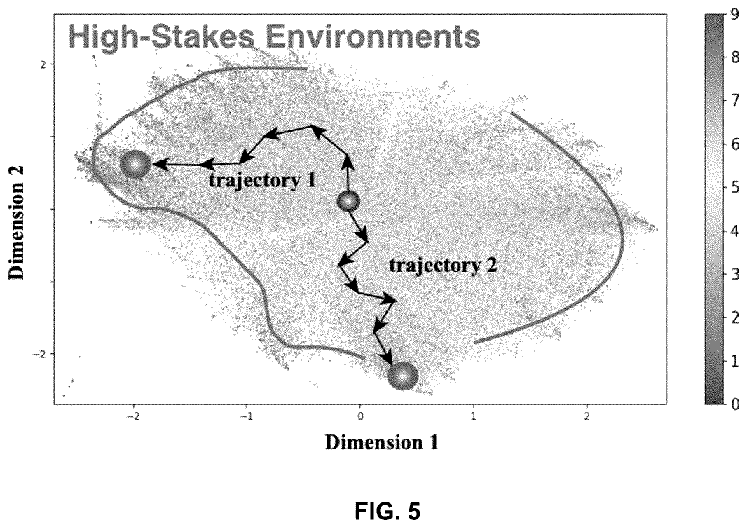

FIG. 5 illustrates anti-hack resilience for unknown and high-stakes zones, according to one or more example embodiments.

An anti-hack safety learning method may be provided. The definition of unknowns can be approximated using the anti-hack approach. In this approach, the resilience of an ML system may be defined in a novel way based on adversarial attacks, as illustrated in FIG. 5. A measure of resilience would then be to relate the number of tests needed to hack the model successfully. Consider a classifier f: X→L, where X represents the input space and L is a set of labels. Inspired by Goodfellow method, it should be noted that given a x∈X, adversarial examples can be generated using the “fast gradient sign method” (FGSM). Let n (f, x) represent the number of queries required using FGSM to compute an adversarial example with a fixed parameter ∈. η(f, x) is the count of FGSM iterations necessary to reach an adversarial example, resulting in notably reduced performance

falling below a predefined threshold. FGSM iterations may be repeated until they consistently reach an adversarial example. Assuming the size of X is n, let ρ(f, n) be defined as the average number of tests to hit adversarial examples for x∈X, calculated as: p (f, n): =(Σx∈X η(f,x))/n, serving f's resilience measure.

In practice, after embedding sentences or images in a vector space, FGSM may be used in the embedded space; the objective is to determine the number of queries required to compromise the system's performance below a threshold. The expected query numbers across trials indicate the system's resilience. Higher hacking query rates imply a more resilient system, while lower rates suggest otherwise. High-stakes environments are the ones with a high hacking query success rate.

The confidence of a trained system may accordingly be measured, and alerts may be triggered if the confidence falls below a predefined standard. The above described contrastive safety confidence measure and the measure in anti-hack safety learning may be used to estimate this confidence. Low confidence scores will trigger an alert prior to system deployment. These alerts may also feed into the revive process, providing valuable insights for learning and improvement.

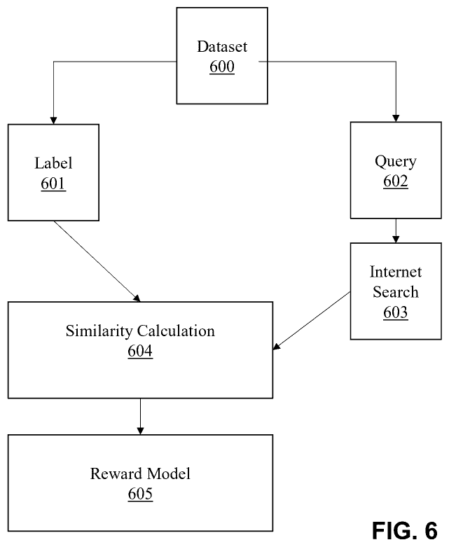

FIG. 6 illustrates a block diagram for training a reward model for fact ecology, according to one or more example embodiments.

For misinformation detection and mitigation, typically the approach in the related art is directed towards text classification. In this regard, they are overly reliant on restrictive restraints tied to ground truth evidence and lack generalization for unseen instances and classes. They do not consider origin of truthful sources and verify source confidence, which are important aspects for identifying reliability of information. Accordingly, a fact ecology is needed for promoting factual responses by learning the credibility of the source websites, allowing for detection of information in an unsupervised manner.

Conventionally, a dataset may be used to obtain a query and label, and responses are learned based on the label only. However, the problem is that unseen and rarely seen events cannot be captured based on this.

According to example embodiments, dataset 600 may be provided. A given data point may be used to extract a sample comprising label 601 and query 602. This may be done by extracting statements from an utterance. Query 602 may be fed into a web API (Internet search 603) to retrieve the sources and the candidates of the texts. For example, extracted statements may be searched from multiple sources considering an interpolated confidence score based on credibility of each source. A similarity calculation 604 such as a cosine similarity may be computed between the web-retrieved candidates and label 601 (acting as the ground truth). This may result in a trustworthy score which reflects the information's truthfulness. The trustworthy score can be applied to any utterance and may be deployed for scanning training data and cleaning models. The result of the comparison may be used as a collected dataset to generate and fine-tune reward model 605 (e.g., DEBERTA) in a supervised manner.

Source credential ranking may be performed, where each source is given a trustworthiness score of each source based on fact checking books, scholarly journals, papers, and news utterance trustworthy scores and their agreements. Label 601 may be normalized cosine similarity scores between the retrieved output and answers to questions from datasets. The source, query, and retrieved results are input features to the fact ecology neural network to predict the likelihood of each retrieved result. Afterwards, the most likely retrieved result may become the final output representing the truth. Importantly, during the decoding phase, a confidence score may be outputted which indicates how certain the system is regarding the generation in relation to evidential facts.

If there is a disagreement among database agents, a further investigation may be performed. For example, a corroboration process may be performed by seeking testimonial cases to validate the verified statements and employ logical inference based on gathered facts from the source search. This process may include proactively collecting related articles and summarizing the content while guiding the corroboration efforts of LLM agents using a designed tree of thoughts.

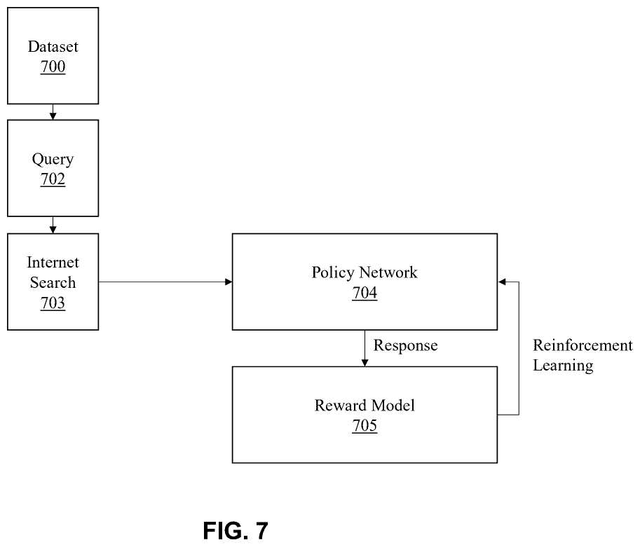

FIG. 7 illustrates a block diagram for performing reinforcement learning on a reward model for fact ecology, according to one or more example embodiments.

The embodiment illustrated in FIG. 7 may be used implemented with the reward model generated based on the example embodiment of FIG. 6 in order to, for example, further train and improve LLM generation using reinforcement learning. Accordingly, the model may be further enhanced.

Dataset 700 may be provided. Query 702 may be sampled from dataset 700, and sources and relevant candidates may be received for query 702 using the web API (Internet search 703). An LLM may receive a RAG prompt along with the query and retrieved candidates, which may be handled using Policy network 704 and Reward model 705. Reward model 705 may predict how similar the response is from the label associated with query 702, and a reward may be used to generate the LLM generation policy using reinforcement learning.

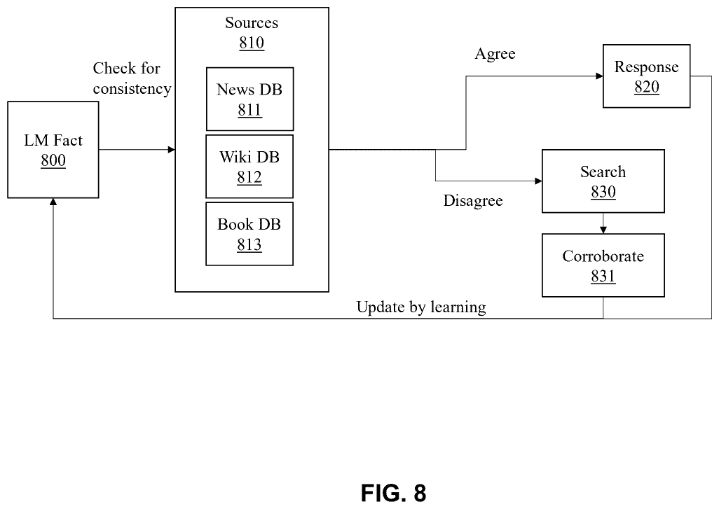

FIG. 8 illustrates a block diagram of an example method for performing a consistency check, according to one or more example embodiments.

LM Fact 800 may be a learning model used for fact checking, and may check the consistency of the facts with sources 810. Sources 810 may include one or more databases such as, but not necessarily limited to database 811, wiki database 812, and book database 813 as examples. If the facts are consistent based on sources 810, response 820 may be issued, and LM fact 800 may be updated based on learning. If not, a further search may be required by search 830. Corroboration of facts by corroboration 831 may be performed based on logical inference based on gathered facts from the source search (as described above with reference to FIG. 6).

In this example embodiment, an LLM agent may be set as a truth examiner. The LLM may be trained on different domains using verified data, such as a wiki database or textbooks (e.g., sources 810). Prior to building the LLM, the method may include scanning training data streamingly. Statements may be extracted by querying verifiable resources from sources 810. Inferences and consistency of these statements may be checked against the sources, flagging and contradictions. Once the LLM examiner is established and used as a black box, it may be used to detect misinformation on a target LLM's outputs.

LLM inspection may also be performed by referring to the LLM examiners as agents that interact with the target LLM by prompting them to detect misinformation using a modularized societal inspection approach. Specifically, the LLM examiners may challenge the target LLM's truthfulness by prompting fact and verifying its consistency to their knowledge. The success and loss numbers of challenges may accumulate over these rounds. The success ratios may provide an introspective index which indicates the likelihood of the LLM producing untruthful utterances and its capability to detect them. The history of these introspections may be used to explain the detection results.

Rather than training a single universal LLM using a mixture of data, it may be preferable to develop a modularized LM trained on verifiable data specific to certain domains (e.g., Wikipedia and news sources). To scale the LLM examiners trained from different aspects, each examiner may be trained within its own domain (for example, separately for each source in sources 810). These examiners may serve as interfaces which patrol the target LLM, and examining target LLM misinformation cases and degrees. For example, an inspection LLM may examine the contradiction between a target LLM response with its own response to identify its validity. Foul responses may be semantically represented in the embedding space and provide alerts. Consequently, semantic areas with a higher detection of misinformation may be inspected more. The above-described anti-hack resilience method may also be used in order to further improve for efficient misinformation detection in some implementations.

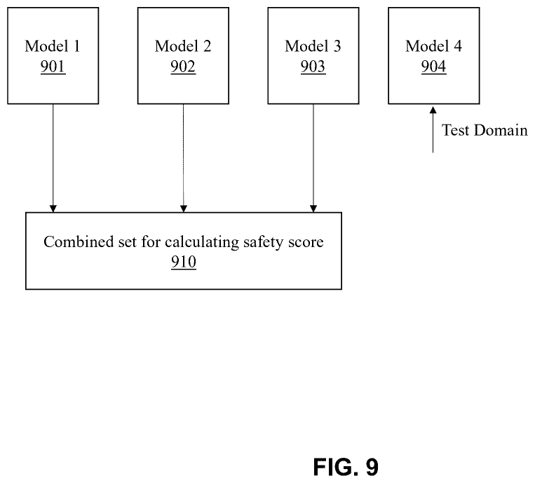

FIG. 9 illustrates an example block diagram of a leave-one-out test for validating safety metrics, according to one or more example embodiments.

It may be assumed that unknown domains can be simulated with a given test sets from different domains. In this scenario, safety metrics may be estimated using leave-one-out error stability by excluding a left-out test set from all available datasets when measuring safety. Particularly, given a specific model, all samples may be collected from tests sets of various domains, randomly selecting a set to leave out, then combining all other tests to compute the safety of the left-out dataset.

A plurality of machine learning (ML) models may be provided, in this example model 1 901, model 2 902, model 3 903, and model 4 904 may be provided. If model 4 904 is selected as the test domain, it may be excluded from the dataset for calculating the safety score. Accordingly, the combined set for calculating the safety score 210 may only include model 1 901, model 2 902, and model 3 903.

According to some implementations, only a limited test domain may be available. Accordingly, the test scores of test domains are discrete values and are difficult to form a distribution. To address this potential issue, a bootstrap algorithm may be modified to construct a collection of subsamples from a combined test set. Correlation may be used with manual evaluation on a pair-wise system comparison to evaluate the leave-one-out evaluation strategy.

According to an example embodiment implementing a chatbot, human linguists may come up with test queries, and evaluate the consistency of model 1 and model 2. The human evaluations may ask as many queries as possible until they may decide on the performance ranking between model 1 and model 2. A perfect safety estimator p may satisfy that the ranking of the safety of two system is the same as the ranking by human ph, such that p(model1)<p(model2) is interchangeable with ph(model1)<ph(model2). In other words, the actual value of p is not necessary to verify that there is enough information to compare two models.

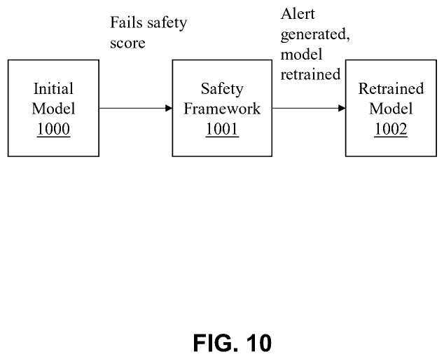

FIG. 10 illustrates an example block diagram of evaluating and retraining a model using a safety framework, according to one or more example embodiments.

Initial model 1000 may be evaluating with respect to its safety metric in comparison to a predefined confidence score. If it fails the test, (e.g., it is below the predefined confidence score), safety framework 1001 may generate an alert, and instruct the system to retrain the model to improve its safety metrics. Accordingly, retrained model 1002 may be obtained.

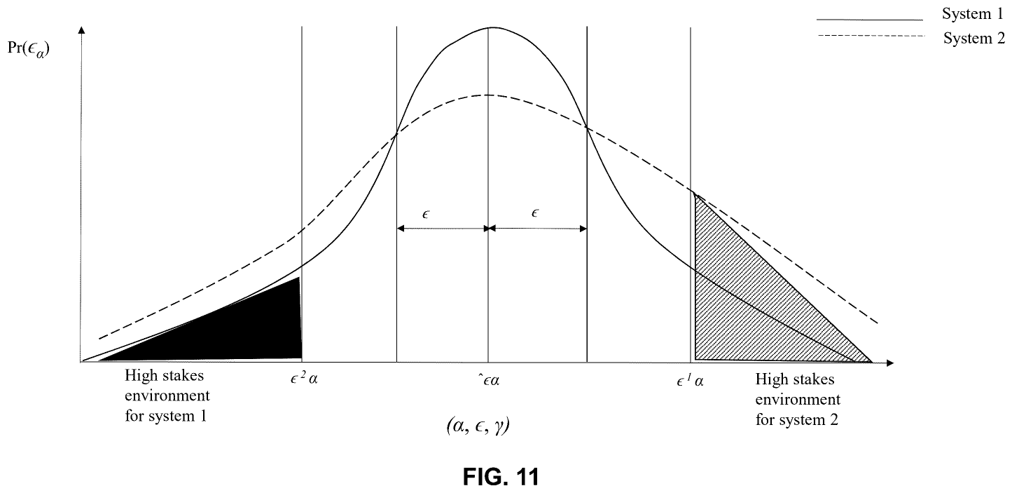

FIG. 11 illustrates an example epsilon-alpha safety curve for defining safety probability, according to one or more example embodiments.—was it mentioned previously? Also, it's in the prior art.

Example embodiments define a unique notion of safety for unknown domains and to be able to rebuild system safety following prediction failures. This is an improvement over conventional accuracy measures on tests sets, which evaluate a system as achieving human-parity quality while failing at rare real-world inputs, thereby alleviating system instability.

A probabilistic-based safety measure may be defined that considers the distribution of the system errors. ∈ may be a tunable parameter setting the expectation on the tolerable error, σ2 is the variance of the errors. The difference between the weighted empirical error \hat{ }∈α and the weighted true error ea may be bounded to some threshold to consider the system as “robust” by introducing the safety factor γ (γ∈[0, 1]) to measure the probability of error difference, and γ is an inverse safety indicator, where the smaller value indicates more robust system and vice versa. A ML system may be called (α, ∈, γ)-robust, if for any source domain Ds and target domain Dt, the difference between the empirical error \hat{ }∈α and the true error ca is bounded through a threshold parameter e with a probability of:—prior art

$$Pr [ \vert {\hat{ϵ}}_{α} - {ϵ}_{α} \vert < ϵ ] \geq 1 - \frac{{σ}^{2}}{{ϵ}^{2}} \cdot γ ,$$

without any assumption on the target domain. However, suppose the target domain knowledge is available. In that case, the bound is extended as:

$$Pr [ \vert {\hat{ϵ}}_{α} - {ϵ}_{α} \vert < ϵ ] \geq 1 - 2 {e}^{\frac{- 2 m {ϵ}^{2}}{\frac{{α}^{2}}{β} + \frac{{( 1 - α )}^{2}}{1 - β}}} \cdot γ$$

where α∈[0, 1] is the weight of the target domain error, β∈[0, 1) is the ratio of target data within all data, and m is a tunable parameter.—equations are prior art

As shown in FIG. 11, tuning ∈ and γ can allow for the probability of the high-stakes environments for system 1 and 2 can be adjusted for the unknown domain, and be defined flexibly. For example, in a challenging prediction task, such as driving in the dark on ice (e.g., system 2) there are more high-stake environments with a fixed error expectations, while in a less challenging prediction task such as image-based cancer detection, there may be higher confidence in prediction. Accordingly, high-stakes environments may occur less in system 1. However, by reducing the error tolerance in expectations, an increase in high-stake environments for both system 1 and system 2 may be observed. Accordingly, there is a theoretical foundation to analyze high-stakes environments across various tasks with varying error tolerances.

Probabilistic (α, ∈, γ) safety as illustrated in FIG. 11 may have a high complexity. For example, the training time may be increased by a large factor. To enhance learning efficiency example embodiments herein may implement importance sampling. In particular, an expectation may be evaluated within the data distribution of one policy, while using data generated by a different policy. This may include computing the likelihood ratio between action probabilities from a target policy and those of a data-producing behavior policy. This method may filter out samples which offer minimal utility for off-policy learning, and favoring “important” samples within a weighted distribution. This may replace the action probability of the behavior policy with their maximum likelihood estimates as derived from observed data. Variance may be minimized resulting from sampling errors in Monte Carlo-style estimators, which may improve the speed of learning in policy gradient algorithms and enhance the accuracy of off-policy policy evaluation.

In the case where the leave-one-out estimation cannot accurate estimate the full distribution on unknowns, or the estimation is likely erroneous, the safety definition may be based on an anti-hack approach. The safety of an ML system may be defined based on adversarial attacks, by relating the number of tests needed to hack the model.

Consider a classifier f: X→L, where X represents the input space and L is a set of labels. Given a x∈X, adversarial examples can be generated using the “fast gradient sign method” (FGSM). Let n (f, x) represent the number of queries required using FGSM to compute an adversarial example with a fixed parameter ∈. η(f, x) is the count of FGSM iterations necessary to reach an adversarial example, resulting in notably reduced performance, falling below a predefined threshold. FGSM iterations may be repeated until they consistently reach an adversarial example. Assuming the size of X is n, let ρ(f, n) be defined as the average number of tests to hit adversarial examples for x∈X, calculated as: ρ(f, n): =(Σx∈X η(f,x))/n, serving f 's safety measure.

In practice, after embedding sentences or images in a vector space, an FGSM may be used in the embedded space, the objective is to determine the number of queries required to compromise the system's performance below a threshold. The expected query numbers across trials indicate the system's safety. Higher hacking query rates imply a more resilient system, while lower rates suggest otherwise. High-stakes environments are the ones with a high hacking query success rate.

A safety definition may be employed to measure the confidence of a trained system and trigger alerts if the confidence falls below a predefined standard as well as optimize the data use and augmentation to opt the system safety. To estimate this confidence, leave-one-out error stability may be used, as discussed with reference to FIG. 9 above. Low safety may result in an alert before the system is deployed.

FIG. 12 illustrates an example block diagram for iteratively retraining a model, according to one or more example embodiments.

A system safety may be enhanced to protect against vulnerabilities. If the system fails, analysis may be performed in order to reflect that the confidence matching is revised accordingly. New datasets for training may need to be generated by incorporating experiences from the failures based on prompt design, growth, and evolution methods.

A trajectory of problem's from the system failures may be used to include the receiving, processing, and decision-making process and generate a labeled sample set (e.g., a lesson take away dataset) for the specific system, task, and domain tested on. When retraining for safety, these trajectories may be inserted as a non-instructional sample for the new system training which avoids the same thinking method as the previous one. Weak predictions of models may be detected, and bootstrapping their performance by prompt learning may be performed. A generalized learning paradigm may be developed to train on unlimited datasets guided by errors observed when using simulated open-domain inputs.

Example algorithms according to example embodiments may optimize for prompt design in order to find labeled data in weak prediction areas (in order to retrain a stronger system using gradient descent). A target model's weak deep learning prediction query areas in the metric space (e.g., the lesson take away dataset from above) may be used to generate prompt samples and a new family of subsampling algorithms considering sample dependencies and model feedback to collect boosting data by prompting. In other words, given a black-box target model and LLM API access, reducing the number of prompts to collect the most effective training dataset is desired, so as to maximize the sample efficiency of prompts. Labels using prompts and control quality of target model performance as feedback (e.g., by performing a random walk in the embedded space) so that families of poorly performing samples are exploited in the prediction accuracy, such that input sentences from unlabeled datapool may be included in the simulated unknown test sets to maximize the performance reward of the training.

Example algorithms may optimize for prompt growth once the system is rebuilt with the new prompt data in order to hack the system with RL so that new weak areas appear that require additional prompts. The target model may be retrained using boosting data and regenerate prompts. This prompt may be improved for sample effectiveness using deep reinforcement learning with loss of target model safety (i.e., high accuracy on unseen domains). This process may be iteratively performed to automatically update a target model (pre-trained model) by fine-tuning on prompt sets iteratively. The series of prompt generation ca be performed sequentially. This may be modeled, for example, by a Markov decision process (MDP) including elements of a set of states a set of states S, a set of actions A, a transition function P:S ×A×S→[0,00), and a reward function R: S→R. Given an MDP (S, A, P, R), the goal of a reinforcement learning system, or an agent, is to learn an optimal policy function x, which is a mapping from the set of states S perceived from the environment E to a set of actions A, or formally π: S→A [131]. The task formulation may be adapted and the RL task may be changed from one prompt optimization to a sequence of prompt optimization. The goal thereof is to find the optimal discrete prompt sequence z*from the search space V generated in the prompt design phase to maximize some downstream performance of the target model measure R of yprompt(z*, x). Each batch of prompts is used to fine-tune the target model, so the R changes over the iterations going on. Assuming the fine-tuning on the prompt batch has fixed time steps of T, the task of discrete prompt sequence optimization may be written in the general format: maxzEVTR(yprompt(z, x)). An agent selects prompt [z1, . . . , zT] one by one to maximize the reward R(yprompt(z, x)). At time step t, the agent receives previous prompts z<t and generates, based on the new fine-tuned target model, the next prompts zt according to a policy π(zt|z<t). After the agent finishes the entire prompt sequence \hat{ }z, it receives the task reward R(yprompt(\hat{ }z, x)). Parameterizing the policy with θ, we can rewrite the problem above as maxθR(yprompt(\hat{ }z, x)), \hat{ }zπ[T,t=1]πθ(zt|z<t).

After training the new model based on the updated prompt data, fine-tuning may be performed on the embedded model to enhance accuracy. The prompt design and prompt growth steps may be repeated iteratively until the system has evolved to a convergence. Accordingly, models may be enhanced until they are more stable and robust. In this regard, the RL in prompt design and growth may require word embedding in order to locate each sample and navigate the learned model's weak areas. The learning procedure may rely on the word's quality and image embedding. The word and image embedding may be updated iteratively whenever new data is augments and iterated until learning converges to the predefined improvement threshold. In this regard, a geometric space may be formed with word and image embedding so as to help improve prompt learning.

This reinforcement learning may also be implemented analogously for fact verification. Since learning relies on word and image embedding, the embedding may also be updated iteratively whenever new data is augmented, and iterated until learning converges. Accordingly, the geometric space formed around the word and image embedding may be improved to help learn from samples to improve a target LLM.

Referring to FIG. 12, initial model 1200 may be provided, along with a prompt set 1202. Iterative model training 1201 may be performed as described above to obtain trained model 1203, and repeated iteratively until trained model 1203 meets the desired parameters (e.g., until it has evolved to a convergence).

This may be implemented in order to identify unexpected behavior and detect atypical data instances in a white-box manner.

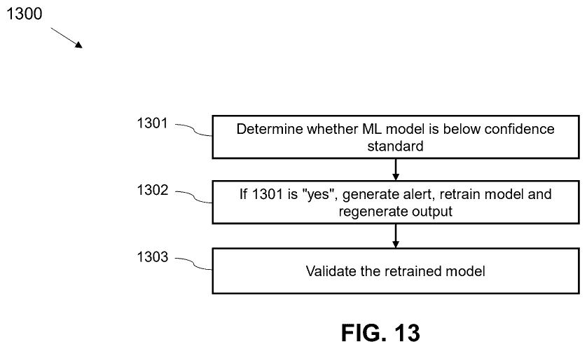

FIG. 13 illustrates an example block diagram of a method for validating model safety, according to one or more example embodiments.

At operation S1301, it may be determined as to whether the machine learning model is below a predefined confidence standard. This may include considering whether a generated response is safe or not with regards to accuracy (e.g., contrastive safety confidence measure) and ethical (anti-hack safety proactive learning).

At operation S1302, if the determination made in operation S1301 above is a “yes”. The safety framework may generate an alert, and retrain the model (based on receiving the alert) accordingly. The output may also be regenerated. The machine learning model may be retrained iteratively based on prompts in weak prediction areas of the Ml model.

At operation S703, the safety framework may validate the retrained model. This may be done using a leave-one-out test in a plurality of domains from the given dataset.

Based on the above embodiments, it can be understood that an example effect which may be achieved includes improving detection of ML models which are below a safety threshold, and improving safety of ML models by retraining. Accordingly, robust ML models may mitigate algorithmic failure (which could otherwise lease to physical harm), improve data privacy, avoid algorithmic bias, and improve ethical decision-making.

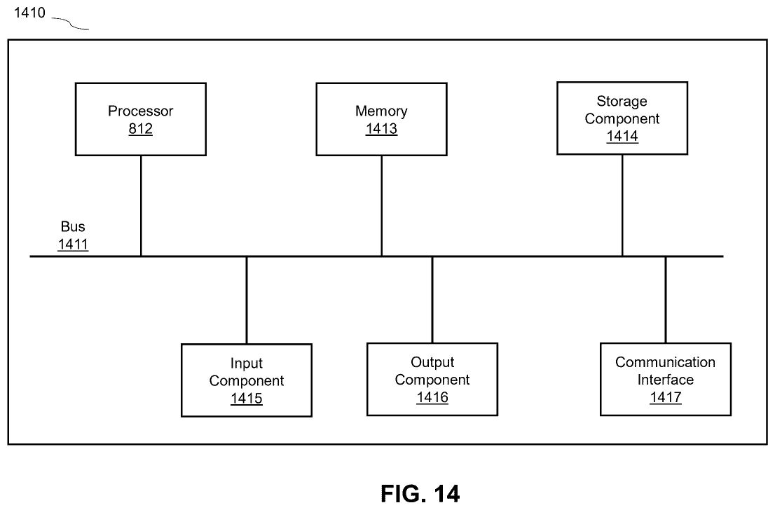

FIG. 14 illustrates a diagram of example components of a system, according to one or more example embodiments. As illustrated in FIG. 14, the system 1410 may include at least one bus 1411, at least one processor 1412, at least one memory 1413, at least one storage component 1414, at least one input component 1415, at least one output component 1416, and at least one communication interface 1417.

It is contemplated that the system 1410 may include more or less components than illustrated in FIG. 14, without departing from the scope of the present disclosure. For instance, in some embodiments, the system 1410 may include a plurality of storage components 1414, the input component 1415 and the output component 1416 may be implemented as a transceiver component, the memory 1413 and storage component 1414 may be implemented as a memory storage, and the like.

The bus 1411 may be configured to facilitate or enable communications among the components of the system 1410. Specifically, the bus 1411 may communicatively couple the components to each other and provide a means for data transfer and flow of control signals between the components. The bus 1411 may include one or more of: an internal bus, an address bus, a data bus, a control bus, a controller area network (CAN) bus, an Ethernet bus, a peripheral component interconnect express (PCIe) bus, and any other suitable type of bus that can be implemented in the system 1410 to enable communication and coordination between the components within the system 1410 in real-time (or near real-time).

The processor 1412 may be implemented in hardware, firmware, or a combination of hardware and software, and may be configured to handle real-time (or near real-time) data processing and control of the control system 1410. The processor 1412 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the system 1410. In some implementations, the processor 1412 may be capable of being programmed to perform one or more operations described herein. Further, the processor 1412 may include a plurality of processing units, each of which is dedicated to performing a specific operation.

The memory 1413 may include one or more mediums for storing temporary data, runtime variables, program instructions, and buffers required for the operations of the control system 1410. The memory 1413 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the system 1410 to store information and/or instructions for use by the processor 1412.

The storage component 1414 may be configured to store non-volatile data, such as firmware, configuration settings, calibration data, information, and/or software related to the operation and use of the system 1410. For example, the storage component 1414 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage component 1414 may be configured to store computer-readable or computer-executable instructions for implementing one or more operations of the system 1410. The storage component 1414 may provide the stored information to the memory 1413 for the execution of the processor 1412.

The input component 1415 may include one or more input components that permit the system 1410 to receive information, such as via user input (e.g., a touch screen display, a keyboard, a keypad, a mouse, a button, a switch, and/or a microphone). The output component 1416 may include one or more output components that provide output information from the system 1410 (e.g., a display, a speaker, a navigation device, one or more light-emitting diodes (LEDs), etc.) According to embodiments, the input component 1415 and/or the output component 1416 may be optional and may be excluded from the system 1410.

The at least one communication interface 1417 may include a transceiver-like component (e.g., a transceiver and/or a separate receiver and transmitter) that enables the system 1410 to communicate with other components (e.g., ECUs, user devices, etc.), such as via a wired connection, a wireless connection, or a combination of wired and wireless connections. For example, communication interface 1417 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 1417 may include at least one input/output (I/O) interface, at least one network interface, at least one storage interface, or the like, that enable the components 1412-1416 to communicate with other components. Further, the communication interface 1417 may include one or more application programming interfaces (APIs) that allow the system 1410 (or one or more components included therein) to communicate with one or more software applications (e.g., software application deployed in the ECUs, etc.)

Computer-executable instructions (e.g., software instructions, etc.) may be read into memory 1413 and/or storage component 1414 from another computer-readable medium or from another device (e.g., a remote server, an external storage, etc.) via, for example, the communication interface 1417. When executed, the computer-executable instructions stored in memory 1413 and/or storage component 1414 may cause the processor 1412 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

### Various Aspects of Embodiments

It is contemplated that features, advantages, and significances of example embodiments described hereinabove are merely examples of the present disclosure, and are not intended to be exhaustive or to limit the scope of the present disclosure.

Specifically, the foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a device, a system, a method, and/or a computer-readable medium at any possible technical detail level of integration. Further, one or more of the above components described above may be implemented as instructions stored on a computer-readable medium and executable by at least one processor (and/or may include at least one processor). The computer-readable medium may include a computer-readable non-transitory storage medium (or media) having computer-readable program instructions thereon for causing a processor to carry out operations.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), electrically erasable programmable read-only memory (EEPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program code/instructions for carrying out operations may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages.

The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects or operations.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other devices to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limited to the implementations. Thus, the operation and behavior of the systems and/or methods were described herein without reference to specific software code—it is understood that software and hardware may be designed to implement the systems and/or methods based on the description herein.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method for validating the safety of a machine learning model, the method comprising:
determining, based on confidence matching, whether the machine learning model is below a predefined confidence standard;
based on determining that the machine learning model is below the predefined confidence standard, generating an alert that the confidence standard is below the predefined confidence standard;
retraining the machine learning model based if alerted;
regenerating an output if alerted, and
validating the retrained machine learning model to determine whether the retrained machine learning model is equal to or above the predefined confidence standard.

2. The method as claimed in claim 1, wherein determining whether the machine learning model is below the confidence measure is based on a contrastive safety confidence measure for the machine learning model.

3. The method as claimed in claim 1, wherein determining whether the machine learning model is below the confidence measure is based on an anti-hack safety definition for the machine learning model.

4. The method as claimed in claim 1, wherein retraining the machine learning model, and validating the retrained machine learning model may be performed iteratively until a hypothesis reaches an expected quality in estimation prior to generating a final output.

5. The method as claimed in claim 1, wherein determining whether the machine learning model is below the confidence measure is based on multimodal consensus.

6. The method as claimed in claim 1, wherein retraining the machine learning model is performed iteratively based on retraining to strengthen learning in weak prediction areas of the machine learning model.

7. The method as claimed in claim 1, wherein validating the retrained machine learning model is based on a robustness measure based on leave-one-out test in a plurality of domains from a given dataset.

8. A computing device comprising:
a memory device configured to store computer-readable instructions; and
a processing device communicatively coupled to the memory device and configured to execute the instructions to validate the safety of a machine learning model by:
determining, based on confidence matching, whether the machine learning model is below a predefined confidence standard;
based on determining that the machine learning model is below the predefined confidence standard, generating an alert that the confidence standard is below the predefined confidence standard;
retraining the machine learning model if alerted;
regenerating an output if alerted; and
validating the retrained machine learning model to determine whether the retrained machine learning model is equal to or above the predefined confidence standard.

9. The computing device according to claim 8, wherein determining whether the machine learning model is below the confidence measure is based on a contrastive safety confidence measure for the machine learning model.

10. The computing device according to claim 8, wherein determining whether the machine learning model is below the confidence measure is based on an anti-hack safety definition for the machine learning model.

11. The computing device according to claim 8, wherein retraining the machine learning model, and validating the retrained machine learning model may be performed iteratively until a hypothesis reaches an expected quality in estimation prior to generating a final output.

12. The computing device according to claim 8, wherein determining whether the machine learning model is below the confidence measure is based on multimodal consensus.

13. The computing device according to claim 8, wherein retraining the machine learning model is performed iteratively based on prompts in weak prediction areas of the machine learning model.

14. The computing device according to claim 8, wherein validating the retrained machine learning model is based on a leave-one-out test in a plurality of domains from a given dataset.

15. A non-transitory computer-readable recording medium having recorded thereon instructions executable by a computing device to cause the computing device to validate the safety of a machine learning model by performing a method comprising:
determining, based on confidence matching, whether the machine learning model is below a predefined confidence standard;
based on determining that the machine learning model is below the predefined confidence standard, generating an alert that the confidence standard is below the predefined confidence standard;
retraining the machine learning model if alerted;
regenerating an output if alerted; and
validating the retrained machine learning model to determine whether the retrained machine learning model is equal to or above the predefined confidence standard.

16. The non-transitory computer-readable recording medium as claimed in claim 15, wherein determining whether the machine learning model is below the confidence measure is based on a contrastive safety confidence measure for the machine learning model.

17. The non-transitory computer-readable recording medium as claimed in claim 15, wherein determining whether the machine learning model is below the confidence measure is based on an anti-hack safety definition for the machine learning model.

18. The non-transitory computer-readable recording medium as claimed in claim 15, wherein retraining the machine learning model, and validating the retrained machine learning model may be performed iteratively until a hypothesis reaches an expected quality in estimation prior to generating a final output.

19. The non-transitory computer-readable recording medium as claimed in claim 15, wherein determining whether the machine learning model is below the confidence measure is based on multimodal consensus.

20. The non-transitory computer-readable recording medium as claimed in claim 15, wherein retraining the machine learning model is performed LLM evolution, see second document.
